(19) United States
(12) Patent Application Publication
(10) Pub. No.: US 2018/0036848 A1
(43) Pub. Date: Feb. 8, 2018

(54) HANDLING DEVICE AND METHOD FOR MONITORING A HANDLING DEVICE

(71) Applicant: J. SCHMALZ GMBH, GLATTEN (DE)

(72) Inventors: Ralf Stockburger, Glatten (DE); Timo Conzelmann, Glatten (DE); Harald Kuolt, Deilingen (DE)

(73) Assignee: J. SCHMALZ GMBH, GLATTEN (DE)

(21) Appl. No.: 15/667,052

(22) Filed: Aug. 2, 2017

(30) Foreign Application Priority Data
Aug. 3, 2016 (DE) 10 2016 114 378.2

(51) Int. Cl. B23Q 3/08; B23Q 3/16; B25B 11/00

(52) U.S. Cl. CPC B23Q 3/088; B25B 11/005; B23Q 3/16

(57) ABSTRACT

The invention relates to a handling device and method for monitoring a handling device having a holding device, in particular a vacuum gripping device or a vacuum tensioning device, for fixing a workpiece, and having a sensor device for detecting vibrations and for generating measured values therefrom. The sensor device is situated on the holding device and is configured for detecting vibrations of the workpiece that is fixed to the holding device.

### CROSS-REFERENCE TO RELATED APPLICATION

The present application relates and claims priority to German Application No. 102016114378.2 filed Aug. 3, 2016, the entirety of which is hereby incorporated by reference.

### BACKGROUND OF THE INVENTION

The present invention relates to a handling device according to claim 1, comprising in particular a holding device for fixing a workpiece, and a sensor device for detecting vibrations and for generating measured values therefrom.

Handling devices of this type are used in machining facilities, for example, for machining workpieces. Such machining facilities include, in addition to the handling device, machining devices such as machine tools, saws, milling cutters, and borers. The workpieces are fixed via the holding device and optionally displaced. In the present context, the holding device is designed in particular as a gripping device or tensioning device. A tensioning device is used in particular for in particular stationarily fixing the workpiece while it is being machined. A gripping device may be designed for displacing or repositioning a workpiece that is fixed to it.

During operation, undesirable vibrations may occur at various parts of the device. The reasons for these vibrations may lie with the machining process itself, for example due to the action of a driven tool (drill, milling cutter, saw, etc.) on the workpiece. However, other moving parts such as drive shafts, flywheels, and motors may also contribute to the generation of vibrations. Vibrations occur in particular when fitting errors, damage, or wear are/is present on the moving parts of the devices (drive damage, gear damage, bearing damage, imbalance, etc.). In addition, the handling operation, for example repositioning of an object by means of a gripper, may result in vibrations when the mechanical influencing variables (forces, masses, accelerations, handling speeds, cycle times, etc.) are inadequately coordinated with one another.

If vibrations occur to an excessive degree, this may result in undesirable loss of quality, damage, and increased wear on the various devices. In addition, noise levels are increased. The vibrations may be transmitted to the workpiece, where they may result in impairment and/or make fixing to the holding device unreliable. In particular, there is a risk that very large vibration amplitudes may occur due to resonance effects in the devices, which may lead to destruction of individual components.

In machine tools it is known to monitor moving machine parts, such as rotating shafts or drive elements, for undesirable vibrations. Methods and devices for vibration analysis of facilities or machine elements are described in DE 10 2011 055 523 A1 or DE 44 05 660 A1, for example. In this regard, suitably positioning the sensors on the moving machine parts in order to detect undesirable vibrations is problematic. DE 10 2006 049 867 A1 describes a machine tool having a tensioning device and a driven tool, wherein the relative vibrations speeds of the tensioning device and the tool are determined by means of sensors.

The object of the invention is to allow reliable handling of workpieces in an easy manner, and to improve the reliability and machining quality for workpieces in machining facilities.

### DESCRIPTION

This object is achieved by the handling device according to claim 1. The handling device includes at least one holding device that is designed for fixing a workpiece to the holding device. In addition, the handling device includes a sensor device that is designed for detecting vibrations and generating measured values therefrom. The sensor device is in particular situated on the holding device. The sensor device is configured and also positioned on the holding device in such a way that oscillations (for example, vibrations, structure-borne noise, longitudinal and/or transverse mechanical vibrations) of the workpiece that is fixed to the holding device are detected in a targeted manner. In this regard, the sensor device is designed primarily not for monitoring vibrations of moving machine parts, but, rather, for monitoring vibrations of the fixed workpiece.

In machining facilities, the holding device is the functional unit that is in direct operative connection with the workpiece. The contact with the workpiece also generally takes place over an extended period, in particular during machining with the machining device. Ongoing, reliable monitoring for the workpiece may thus be achieved due to the arrangement of the sensor device on the holding device. Problematic arrangement of sensors on moving machine parts such as drive shafts or pistons is thus unnecessary.

The measured values determined by means of the sensor device in particular allow control of the handling process to be carried out with the handling device. In particular, by monitoring the vibrations it may be determined whether the workpiece is fixed via the holding device, and/or whether sufficient or reliable fixing has taken place. In addition, conclusions concerning other impairments of the handling process and/or machining process may be drawn based on the vibration behavior. The following are examples of such impairments: Unsuitable process parameters for the machining, excessive cycle rates, movement sequences with excessive acceleration, for example during repositioning of the workpieces, imprecise positioning of the holding device with regard to the machining device and/or on the workpiece, worn or inappropriate tools, etc.

The holding device is designed in particular as a vacuum holding device, the workpiece being fixable to the holding device by means of a vacuum. This may be a suction gripper or a suction tensioning device, for example. In vacuum holding devices of this type, by monitoring the vibrations of the workpiece it can be recognized whether the workpiece is resting against the holding device (presence control) and/or whether the workpiece is reliably fixed and/or whether the workpiece is correctly positioned. In this regard, it is known in the prior art to monitor the handling process of a vacuum handling device, for example by measuring the effective pressure for fixing the workpiece. The described embodiment provides an alternative, reliably and easily functioning option for monitoring the handling process. In addition, information concerning a machining process carried out on the fixed workpiece and/or concerning a handling operation (repositioning, displacement, for example) carried out with the fixed workpiece may be obtained.

One advantageous design results from the holding device having a housing (for example, a housing of a vacuum tensioning device, suction gripper, or the like), and the sensor device being integrated into the housing of the holding device.

The holding device in particular has a contact section that rests against the workpiece in order to fix it. The holding section may, for example, be a side of the housing of the holding device facing the workpiece. The holding section may also be formed by an additional component, for example a suction plate of a surface gripper, a support surface of a tensioning device, or the like.

According to one advantageous embodiment, the sensor device has at least two vibration sensors, one vibration sensor being situated on the contact section, and a second vibration sensor being situated on a section of the holding device spaced apart from the contact section. The contribution of the workpiece vibration may be determined in a targeted manner by comparing the measurements of the two sensors. In addition, reference measurements may be carried out, resulting in more accurate data evaluation.

In addition, an evaluation device is preferably provided which is supplied with the measured values as input values. It is particularly advantageous when the evaluation device is also situated on the holding device. This has the advantage that the holding device in a fairly complex handling device may act as an independent modular monitoring unit in addition to its function for fixing the workpiece. In particular, the evaluation device may be integrated into a housing of the holding device.

However, in principle it may also be advantageous when the evaluation device is not situated on the holding device. In this regard, the embodiments of the evaluation device explained below may also be provided, regardless of the specific mounting position of the evaluation device.

In particular a memory device, in which the measured values and/or the results of an evaluation of the measured values by the evaluation device, may also be associated with the evaluation device. In this way, the course of a handling process may be recorded as a function of time, and may be read out at the handling device itself if necessary.

According to one particularly advantageous aspect of the invention, the evaluation device is designed for processing the measured values by means of a data processing program stored in the evaluation device, and generating a processing result. In addition, it may be provided that an error signal is generated in the event of noncompliance with a limit value criterion stored in the evaluation device (i.e., when results of the evaluation are outside a tolerance range defined by at least one limit value).

If the sensor device detects, for example, vibrations via a parameter (for example, intensity, amplitude, (vibration) path, (vibration) speed, (vibration) acceleration, or the like) that exceeds a certain threshold value regarded as critical, this indicates that the workpiece is not correctly fixed, or the handling process is impaired in some other way (for example, excessively rapid changes in movement by means of a gripping device, wrong or worn tools in an associated machining device, excessive machining intensity, or the like). In addition, as described, the evaluation device thus determines an evaluation result that is outside the limit value criterion. Outputting of an error signal then allows corrective intervention to be made in the handling process.

The error signal may, for example, be an electrical signal that is supplied to a data output unit for providing measuring results and/or warning signals. It is also conceivable for the evaluation unit to directly generate visual, acoustic, or other warning signals.

In another embodiment, means may be provided for damping or intensifying the vibrations or certain vibration components that act on the holding device. Passive or active devices may be provided for this purpose.

For example, at least one passive absorber element may be provided which is designed for absorbing and/or damping vibrations that are transmitted from the workpiece to the holding device. The at least one absorber element is preferably situated on the holding device.

It is also conceivable for the holding device to have a resonance device that may be set into resonance with vibrations of a defined frequency range. Certain vibration components may be intensified in a targeted manner by means of the resonance device. A controlled coupling of the holding device to a vibrating workpiece may be achieved in this way.

It may also be advantageous for the holding device to have an actively driven [or] drivable vibration actuator. The vibration actuator is in particular designed for actively generating (counter-)vibrations at the holding device in order to at least partially compensate for vibrations of the fixed workpiece. The vibration actuator includes, for example, an actively driven inertia weight, such as a rotationally and/or oscillatingly driven flywheel. It is thus possible not only to achieve more reliable monitoring, but also to actively counteract impairment due to vibrations.

According to one advantageous embodiment, it is provided that the above-mentioned evaluation device cooperates with the vibration actuator and controls the vibration actuator as a function of the measured values.

Depending on the intended purpose, it may be advantageous to provide the above-mentioned means (absorber elements, vibration actuators, and/or resonance devices) in each case optionally, alternatively, or complementary to one another.

A simple sensor device may include, for example, a switching element that switches when a certain degree of the action is exceeded, and in this regard forms a discretely responsive sensor. However, it is also advantageous when the sensor device allows continuous, incremental monitoring, i.e., is designed in such a way that a distinction may be made between various intensities of the action.

A reliable measurement of oscillations and/or vibrations may be achieved, for example, by the sensor device including or being formed by an acceleration sensor and/or a structure-borne noise sensor.

A transmission portion is preferably provided for transmitting vibrations of the workpiece to the sensor device. The transmission portion is in particular designed for absorbing vibrations acting on the contact section of the holding device and transmitting them to the sensor device. For example, the transmission portion may be formed by a fluid spring, a compressed air spring, a plunger, or the like. The transmission portion generally has the function of transmitting vibration energy from the workpiece to the sensor device.

In another embodiment, the holding device has data transmission means for communicating with a higher-level control device (a machine controller, for example) and/or with a memory device. The data transmission means may be designed for direct communication with the control device, or for indirect communication via a network, for example. According to one advantageous embodiment, the data transmission means are designed for wireless communication. The data transmission means may also be designed as a connecting element for a data bus, IO link, or the like.

The data transmission means may be designed for transmitting the measured values of the sensor device and [sic; to] the control device. It is conceivable in particular for the data transmission means to cooperate with the mentioned evaluation device and to transmit the evaluation results to the control device and/or transmit error messages.

In addition to the sensor device for measuring vibrations, further sensors may be provided, such as a pressure sensor (for example, for monitoring a vacuum for fixing the workpiece), a force sensor, a displacement measuring device, etc. Even more comprehensive monitoring of the handling process and/or of the machining process may thus be made possible.

The handling device may be part of a more complex machining facility for workpieces. Such machining facilities include at least one handling device of the stated type, and at least one machining device for machining the workpiece, for example a machine tool such as a circular saw, milling cutter, or borer.

The above-mentioned object is also achieved by a method for monitoring a handling device, and by a method for monitoring the operation of a handling device. For this purpose, the handling device includes at least one holding device for fixing a workpiece, and a sensor device for detecting vibrations. Vibrations of the workpiece fixed to the holding device are detected by means of the sensor device. The monitoring thus made possible allows corrective intervention to be made in the handling operation when it does not meet the desired criteria. In this regard, the reliability of the handling process may be improved by the method.

The method may basically be designed using all measures explained in conjunction with the handling device.

An evaluation of the measuring results obtained with the sensor device, for example using the evaluation unit explained above, preferably takes place. As described, the evaluation is carried out in particular in such a way that an error signal is generated in the event of noncompliance with a defined limit value criterion (i.e., when results of the evaluation are outside a tolerance range defined by at least one limit value). It is conceivable to generate an error signal when the detected vibrations differ from a predefined setpoint value. The evaluation may also take place in such a way that a warning signal is generated when the detected vibrations or vibration components change over time. As explained, it is also particularly advantageous when certain vibration components are absorbed and/or damped by an absorber element. On the other hand, certain vibration components may be intensified by a resonance device so that these components may be better evaluated. In addition, as explained, certain vibration components may be compensated for with a drivable vibration actuator of the holding device. According to the method, further sensor signals may additionally be evaluated, for example measured pressure values, measured distance values between the holding device and the workpiece, or the like.

The invention is explained in greater detail below with reference to the figures, which show the following:

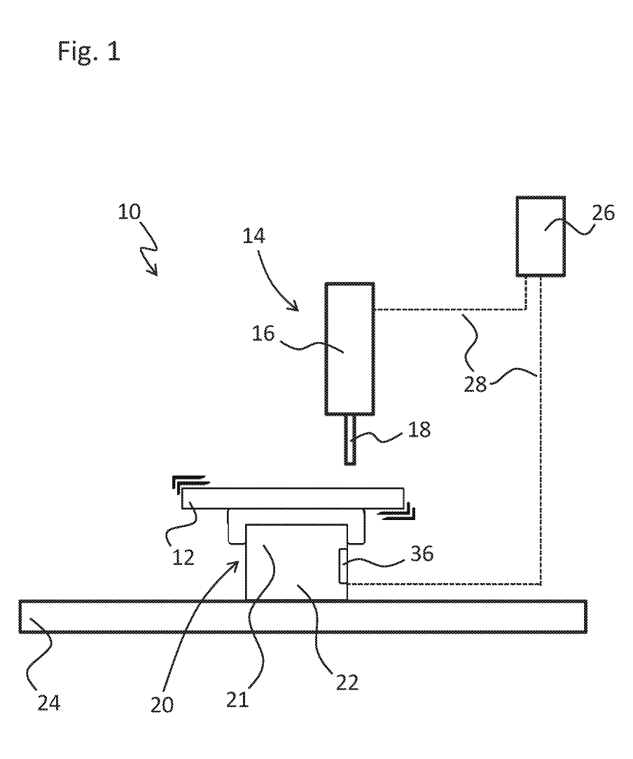

FIG. 1: shows a schematic illustration of a machining facility with a handling device according to the invention; and

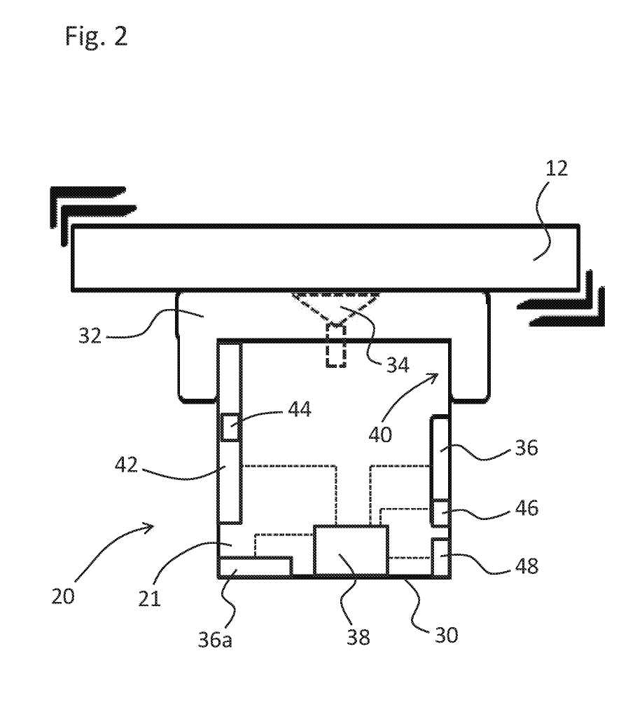

FIG. 2: shows a schematic illustration of a handling device according to the invention.

The same reference numerals are used in each case for identical or corresponding features in the following description and in the figures.

FIG. 1 schematically illustrates a machining facility 10 for machining a plate-like workpiece 12, for example. The machining facility 10 includes a machining device 14, which in the illustrated example is designed as a milling device 16 having an actively driven milling tool 18.

In addition to the machining of the workpiece 12 with the machining device 14, handling of the workpiece 12 also takes place in the machining facility 10. For this purpose, a handling device 20 is provided, by means of which the workpiece 12 may be fixed. For example, the workpiece 12 is fixed, and by means of a movement actuator (not illustrated) of the handling device 20 the workpiece is repositioned, and, for example, taken to another machining station. In this case, the handling device includes a gripping device. On the other hand, the handling device 20 may fix the workpiece while it is being machined, the handling device including a tensioning device.

In the illustrated example, while being machined the workpiece 12 is fixed by means of a holding device 21 of the handling device 20. The holding device 21 is thus designed as a vacuum tensioning device 22 in the illustrated example. The vacuum tensioning device 22 is situated on a machine table 24 so that the workpiece 12 is stationarily fixable during the machining.

For controlling the machining device 14 and/or the holding device 21, in the illustrated example a higher-level control device 26 is provided as a machine controller, which communicates with the machining device 14 and/or the holding device 21 via appropriate signal transmission paths 28.

The holding device 21 schematically illustrated in FIG. 2 has a housing 30, whose side facing the workpiece 12 is provided with a schematically illustrated suction plate 32. In the illustrated example, the suction plate 32 forms a contact section of the holding device 21. The contact section (in the present case, the suction plate 32) in the illustrated example has a schematically illustrated suction opening 34 that is connected to a vacuum supply system, not illustrated in greater detail. When the workpiece 12 is resting against the contact section 32, the workpiece 12 may be fixed by the action of a vacuum on the suction opening 34.

In the illustrated example, the holding device 21 has a sensor device 36 and a further sensor device 36a. The sensor device 36 is situated on an area of the holding device 21 facing the contact section 32, and is preferably integrated into the housing 30. The sensor device 36a is situated on a section of the holding device 21 facing away from the contact section (preferably likewise integrated into the housing 30, but at a farther distance from the contact section 32 than the sensor device 36). The sensor devices 36, 36a are sensors for detecting vibrations. Based on the detected vibrations, the sensor devices generate measured values that may be supplied to an evaluation device 38 (signal paths are depicted by dashed lines).

In particular, the sensor device 36 is situated in such a way that vibrations of the workpiece 12 resting against the contact section 32 may be detected. The vibrations are symbolized in the figures by double lines at the corners of the workpiece. For transmitting the vibrations of the workpiece 12 to the sensor device 36, the holding device 21 may have appropriate transmission portions 40. The further sensor device 36a allows, for example, reference measurements to be carried out and/or the vibrations of the workpiece 12 to be more accurately measured.

The holding device, as schematically illustrated in FIG. 2, has means 42 for damping, intensifying, or influencing in a defined manner the vibrations or certain vibration components acting on the holding device. For example, these means 42 may include an absorber element with which certain vibrations or oscillations may be absorbed. The means 42 may also have a resonance device that may be brought into resonance with vibrations of a defined frequency range. As an alternative or in addition to such passive means, the means 42 may also have an active design in order to act on the vibration. For example, the means 42 may include a drivable vibration actuator 44 which has, for example, an actively driven inertia weight for generating counter-vibrations.

As explained above, the evaluation unit 38 is designed for evaluating the measured values of the sensor device 36 (and optionally 36a). In particular, it is provided that the evaluation device 36 generates an error signal when the evaluated results do not comply with a defined limit value criterion (for example, when the detected vibrations have an excessively high deflection, amplitude, speed, or acceleration). It is also conceivable for the evaluation device 38 to control the vibration actuator 44 in order to generate a corresponding counter-vibration for compensating for the detected vibration.

The holding device 21 may have a data output unit 46, by means of which evaluation results of the evaluation unit 38 and/or the mentioned error signals may be output. For example, this may be a visual or acoustic data output.

The holding device 21 may also have data transmission means 48, for example to communicate with the control device 26. The data transmission means 48 may be designed, for example, as a bus interface or as an interface for wireless communication.

What is claimed is:

1. A handling device
having a holding device, in particular a vacuum gripping device or a vacuum tensioning device, for fixing a workpiece,
and having a sensor device for detecting vibrations and for generating measured values therefrom, the sensor device being situated on the holding device and being configured and positioned in such a way that vibrations of the workpiece that is fixed to the holding device are detected.

2. The handling device according to claim 1, characterized in that an evaluation device is provided which is supplied with the measured values as input values, the evaluation device being situated on the holding device.

3. The handling device according to claim 2, characterized in that the evaluation device is designed for processing the measured values by means of a data processing program stored in the evaluation device, and for generating an error signal in the event of noncompliance with a limit value criterion stored in the evaluation device.

4. The handling device according to claim 1, characterized in that the holding device has at least one absorber element that is designed for absorbing and/or damping vibrations that are transmitted from the workpiece to the holding device.

5. The handling device according to claim 1, characterized in that the holding device has a drivable vibration actuator that is designed for actively generating vibrations at the holding device in order to compensate for vibrations of the fixed workpiece.

6. The handling device according to claim 1, characterized in that the holding device has a resonance device that may be set into resonance with vibrations of a defined frequency range.

7. The handling device according to claim 1, characterized in that the holding device has data transmission means for communication, in particular wireless communication, with a higher-level control device.

8. A method for monitoring the operation of a handling device during the handling of a workpiece, having a holding device for fixing a workpiece, and having a sensor device for detecting vibrations, wherein the method comprises, detecting vibrations of the workpiece that is fixed to the holding device by means of the sensor device.
